(19) United States
(12) Patent Application Publication
(10) Pub. No.: US 2016/0291339 A1
(43) Pub. Date: Oct. 6, 2016

(54) BACKLIGHT APPARATUS AND THREE-DIMENSIONAL (3D) DISPLAY APPARATUS INCLUDING THE SAME

(71) Applicant: SAMSUNG ELECTRONICS CO., LTD., Suwon-si (KR)

(72) Inventor: Katsumi MINAMI, Hwaseong-si (KR)

(73) Assignee: SAMSUNG ELECTRONICS CO., LTD., Suwon-si (KR)

(21) Appl. No.: 15/086,434

(22) Filed: Mar. 31, 2016

(30) Foreign Application Priority Data
Apr. 1, 2015 (KR) 10-2015-0046032

(51) Int. Cl. G02B 27/22; G02B 27/26; H04N 13/04; F21V 8/00

(52) U.S. Cl. CPC G02B 27/2214; G02B 6/0038; G02B 6/0068; G02B 27/26; G02B 6/0051; H04N 13/0452; H04N 13/0497; H04N 13/0409; H04N 2013/0077

(57) ABSTRACT

Disclosed herein are a backlight apparatus of providing light of different colors sequentially to provide a 3 Dimensional (3D) image of a high resolution, and a display apparatus including the backlight apparatus. The backlight apparatus according to an embodiment includes: a light source configured to sequentially generate light of different colors; and a light guide plate configured to receive the light of different colors and emits the light toward a plurality of viewpoints.

### CROSS-REFERENCE TO RELATED APPLICATION

This application claims priority from Korean Patent Application No. 10-2015-0046032, filed on Apr. 1, 2015, in the Korean Intellectual Property Office, the disclosure of which is incorporated herein by reference in its entirety.

### BACKGROUND

1. Field

Apparatuses consistent with exemplary embodiments relate to a backlight apparatus for providing light to a display panel, and a display apparatus including the same.

2. Description of the Related Art

In general, a display apparatus represents an apparatus including a display panel on which images are displayed. The display apparatus includes, for example, a television (TV) or a monitor.

The display apparatus can display two-dimensional (2D) images through a display panel in the shape of a flat panel. Recently, research for utilizing a display apparatus to display three-dimensional (3D) images is conducted.

One method for a display apparatus to display 3D images utilizes a viewer's binocular disparity. Specifically, the display apparatus can display a left image to be recognized by a viewer's left eye and a right image to be recognized by the viewer's right eye, at the same time, through a display panel, to generate the 3D effect for the viewer.

### SUMMARY

Therefore, aspects of the exemplary embodiments provide a backlight apparatus for sequentially providing light of different colors to provide a three-dimensional (3D) image of a high resolution, and a display apparatus including the backlight apparatus.

Additional aspects of exemplary embodiments will be set forth in part in the description which follows and, in part, will be understood from the description, or may be learned by practice of the disclosure.

In accordance with one aspect of the exemplary embodiments, this is provided a backlight apparatus including: a light source configured to sequentially generate first light of a first color and a second light of a second color; and a light guide plate configured to receive the first light and the second light, the light guide plate comprising a plurality of exit areas configured to emit the first light and the second light toward a plurality of viewpoints.

The light guide plate may include: a first surface onto which the first light and the second light generated by the light source are incident; a second surface through which the first light and the second light exits; and a third surface, opposite the second surface, wherein the plurality of exit patterns are arranged at regular intervals on the third surface and the plurality of exit patterns reflect light incident through the first surface toward the plurality of viewpoints through the second surface.

The first light and the second light display a plurality of sub viewpoint images constructing a plurality of different viewpoint images at the plurality of viewpoints.

The light source may sequentially generate the first light and the second light for each frame period of the plurality of different viewpoint images.

The light source may sequentially generate red light, green light, and blue light in a predetermined order.

The light source may sequentially generate cyan light, magenta light, and yellow light in a predetermined order.

The backlight apparatus may further include a second light source configured to sequentially generate second light of the first color and first light of the second color toward the second surface.

The second light source may be positioned behind the third surface, and the second light of the first color and the first light of the second color generated by the second light source are incident to the light guard plate through the third surface and then exits through the second surface.

The plurality of exit areas may extend perpendicularly to an incidence direction of the light generated by the first light source on a surface of the light guide plate.

The plurality of exit areas may extend in a predetermined direction across the surface of the light guide plate.

In accordance with one aspect of exemplary embodiments, this is provided a display apparatus including: a backlight apparatus configured to sequentially emit first light of a first color and second light of a second color toward a plurality of viewpoints from a plurality of predetermined areas arranged at regular intervals; and a display panel configured to transmit the first light and the second light to provide a plurality of different sub viewpoint images at the plurality of viewpoints.

The backlight apparatus may include: a light source configured to sequentially generate the first light and the second light; and a light guide plate configured to receive the first light and the second light, the light guide plate comprising a plurality of exit areas configured to emit the first light and the second light toward a plurality of viewpoints.

The light guide plate may include: a first surface onto which the first light and the second light generated by the light source are incident; a second surface through which the first light and the second light exits; and a third surface opposite to the second surface, wherein the plurality of exit patterns are arranged at regular intervals on the third surface and the plurality of exit patterns reflect light incident through the first surface toward the plurality of viewpoints through the second surface.

The first light and the second light sequentially display the plurality of sub viewpoint images constructing the plurality of different viewpoint images at the plurality of viewpoints.

The first light source sequentially generates the first light and the second light for each frame period of the plurality of different viewpoint images.

The light source may sequentially generate red light, green light, and blue light in a predetermined order.

The light source may sequentially generate cyan light, magenta light, and yellow light in a predetermined order.

The display apparatus may further include second light source configured to sequentially generate second light of the first color and first light of the second color toward the second surface of the light guide plate.

The second light source may be positioned behind the third surface, and the second light of the first color and the first light of the second color generated by the second light source are incident to the light guard plate through the third surface and then exits through the second surface.

The plurality of exit areas may extend perpendicularly to an incidence direction of the light generated by the first light source on a surface of the light guide plate.

The plurality of exit areas may extend in a predetermined direction on a surface of the light guide plate.

### BRIEF DESCRIPTION OF THE DRAWINGS

The above and other aspects will become apparent and more readily appreciated from the following description of the exemplary embodiments, taken in conjunction with the accompanying drawings of which:

FIG. 1 illustrates a display apparatus according to an exemplary embodiment;

FIG. 2 illustrates an exploded perspective view of a display apparatus according to an exemplary embodiment;

FIG. 3 illustrates a perspective view of a configuration of a backlight apparatus according to an exemplary embodiment;

FIGS. 4A and 4B illustrate views describing operation of a backlight apparatus according to an exemplary embodiment;

FIG. 5A illustrates a perspective view describing a 3 Dimensional (3D) image providing method of a display apparatus according to an exemplary embodiment.

FIG. 5B illustrates a cross-sectional view describing a 3D image providing method of a display apparatus according to an exemplary embodiment;

FIGS. 6A and 6B illustrate views describing a space division driving method and a time division driving method;

FIG. 7 illustrates a view describing operation of a first light source according to an exemplary embodiment;

FIG. 8 illustrates a view describing an image displayed on a display apparatus according to an exemplary embodiment and an image recognized by a user;

FIGS. 9A and 9B illustrate views describing operation of a backlight apparatus according to an exemplary embodiment; and

FIG. 10A illustrates a perspective view for describing a 2 Dimentional (2D) image providing method of a display apparatus according to an exemplary embodiment.

FIG. 10B illustrates a cross-sectional view for describing a 2D image providing method of a display apparatus according to an exemplary embodiment.

### DETAILED DESCRIPTION OF EXEMPLARY EMBODIMENTS

Hereinafter, a display apparatus and a control method thereof will be described in detail with reference to the accompanying drawings.

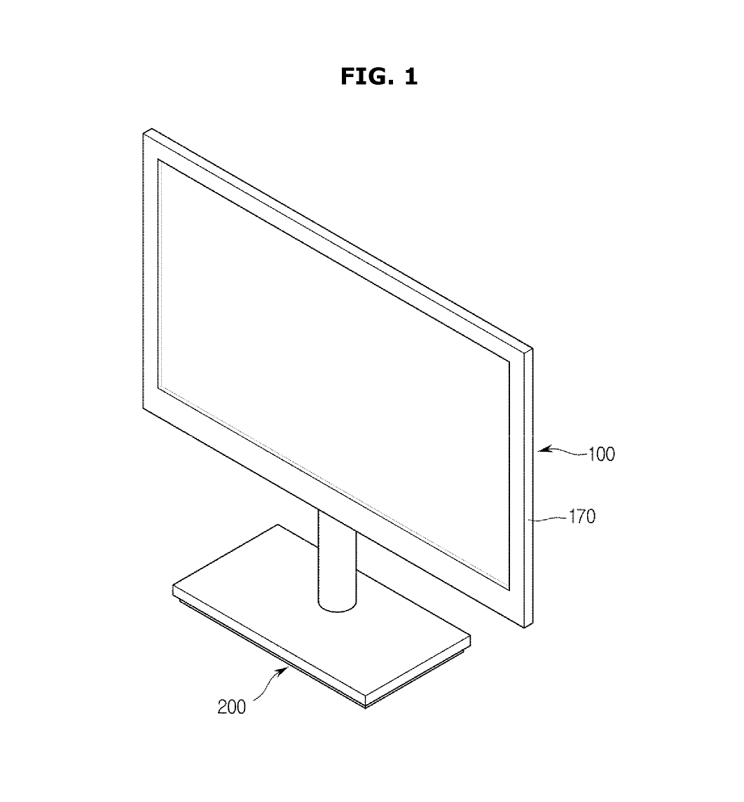

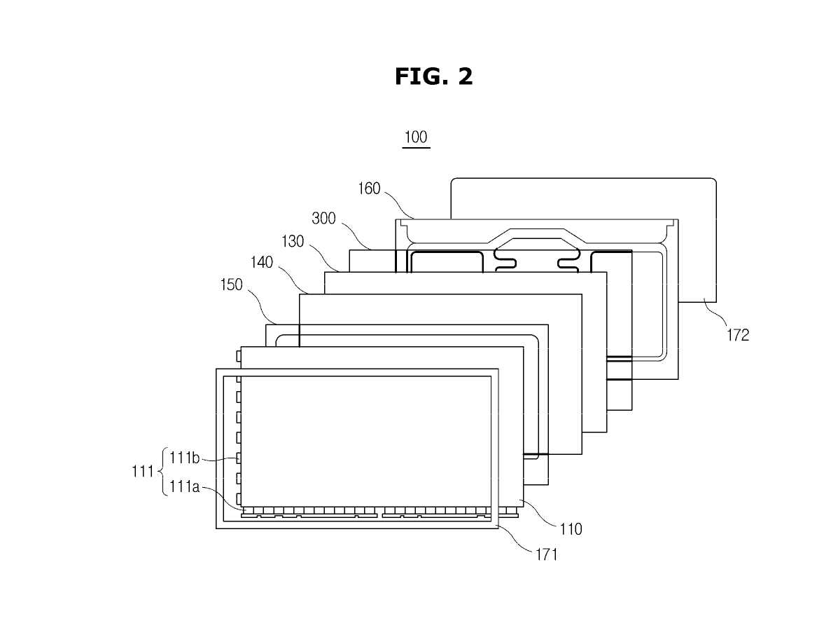

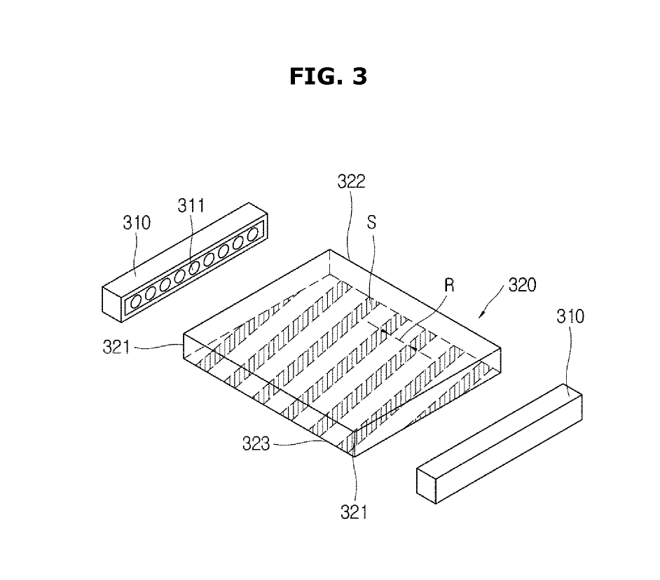

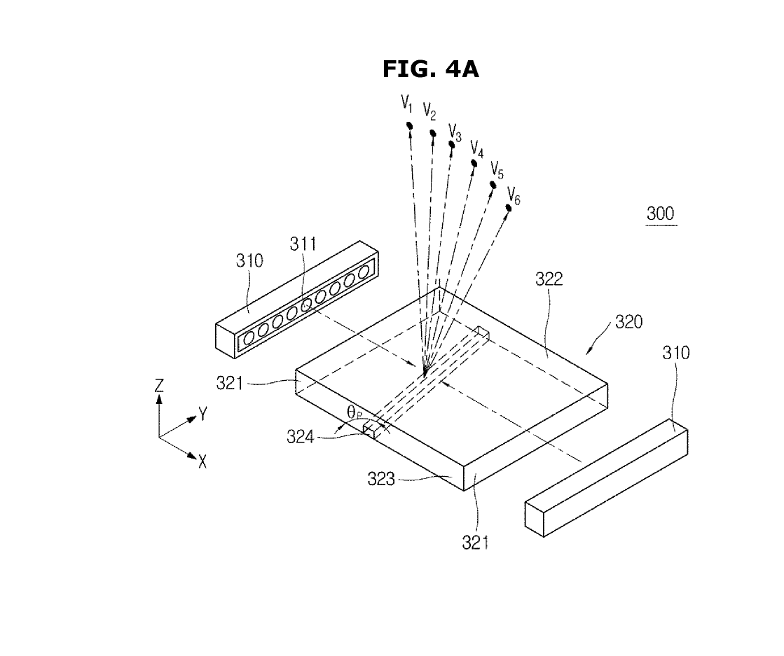

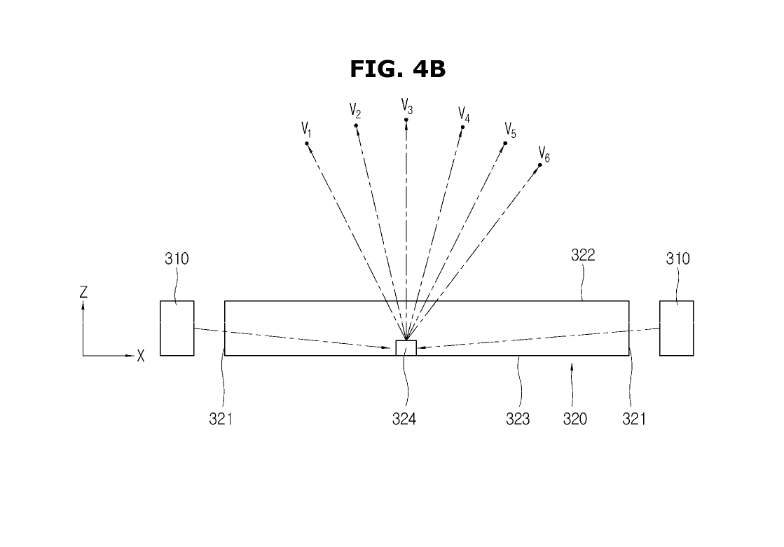

FIG. 1 shows an outer appearance of a display apparatus according to an exemplary embodiment, FIG. 2 is an exploded perspective view of a display apparatus according to an exemplary embodiment, FIG. 3 is a perspective view showing a configuration of a backlight apparatus according to an exemplary embodiment, and FIGS. 4A and 4B are views for describing operation of a backlight apparatus according to an exemplary embodiment. In the backlight apparatus of FIGS. 4A and 4B, a light emitting pattern 324 is shown for illustration of the operation of the backlight apparatus.

A display apparatus 100, which displays images, may be a a television, a monitor, or a mobile communication terminal.

As shown in FIG. 1, the display apparatus 100 may display images and output sound. However, an external speaker may be used to output sound instead of an embedded speaker of the display apparatus.

The display apparatus 100 may be supported by a stand 200 attached onto the lower part thereof, or may be installed on a wall through a bracket or the like.

In this exemplary embodiment, the display apparatus 100 may be a Liquid Crystal Display (LCD) that adjusts a transmittance of light emitted from a backlight apparatus to display images through a display panel.

As shown in FIG. 2, the display apparatus 100 may include a display panel 110, a backlight apparatus 300, a diffusion plate 130, an optical sheet 140, a support member 150, a chassis 160, and a plurality of housings 170 including a bezel 171 and a cover 172.

The display panel 110 may adjust a transmittance of light passing through a liquid crystal layer to display images, such as characters, figures, arbitrary icons, and the like. The transmittance of light passing through the liquid crystal layer may be adjusted according to an applied voltage.

The display panel 110 may include a Thin Film Transistor (TFT) panel, a liquid crystal layer, and a sealant.

The TFT panel of the display panel 110 may include a plurality of gate lines, a plurality of data lines, and a plurality of pixel electrodes. The gate lines may be arranged in the direction of rows to transfer gate signals, the data lines may be arranged in the direction of columns to transfer data signals, and the pixel electrodes may be connected to the gate lines and the data lines and include switching devices and maintenance capacitors.

The switching devices may be disposed at intersections of the gate lines and the data lines, and the maintenance capacitors may be connected to the output terminals of the switching devices. Also, the other terminals of the maintenance capacitors may be connected to a common voltage or to the gate lines.

The liquid crystal layer of the display panel 110 may be opposite to the TFT panel. The liquid crystal layer may include a sealing material and liquid crystals accommodated in the sealing material. The liquid crystal layer may change its orientation depending on an applied voltage so that a transmittance of light passing through the liquid crystal layer can be adjusted.

In addition, the TFT panel and the liquid crystal layer of the display panel 110 may configure a liquid crystal capacitor, and the liquid crystal capacitor may be connected to the output terminals of the switching devices of the pixel electrodes and the common voltage or a reference voltage.

The sealant may surround the borders of the TFT panel of the display panel 110 to maintain the display panel 100 in shape.

The display panel 110 may further include an image driver 111.

The image driver 111 may include a first driver 111a to drive X electrodes, and a gate driver 111b to drive Y electrodes, wherein the X electrodes are source electrodes, and the Y electrodes are gate electrodes. The first driver 111a and the second driver 111b may be connected to a driving module.

The first driver 111a may select a gray-scale voltage for each data line based on image data, and transfer the selected gray-scale voltage to the liquid crystals through the data line.

The second driver 111b may transfer on-off signals based on image data to thin-film transistors (TFTs) that are switching devices, through scanning lines, to turn on or turn off the TFTs.

That is, if the first driver 111a supplies voltages corresponding to color values, the second driver 122b may transfer signals to turn on a corresponding TFT and thus the voltages are applied to the corresponding pixels 111.

The source electrodes of the TFTs may be connected to the data lines, the gate electrodes of the TFTs may be connected to the scanning lines, and the drain electrodes of the TFTs may be connected to the pixel electrodes of Indium Tin Oxide (ITO). When scanning signals are respectively supplied to the scanning lines, the TFTs may be turned on to transfer data signals from the data lines to the pixel electrodes.

If a predetermined voltage is applied to the common electrodes, an electric field may be formed between the common electrodes and the pixel electrodes. Due to the electric field, the orientation angle of liquid crystal molecules between liquid crystal panels may change so that a light transmittance may change according to the changed orientation angle of liquid crystal molecules, thereby a desired image is displayed.

The driving module may provide gate driving signals and data driving signals respectively to the gate lines and the data lines formed on the TFT panel, based on a gate control signal, a data control signal, and a related data signal, thereby forming a desired image on the display panel 110.

The display panel 110 may include a plurality of pixels 111 arranged two-dimensionally to display an image. The pixels 111 may include intersections of the gate lines and the data lines and liquid crystals corresponding to the intersections. If the light transmittance of the liquid crystals changes as described above, the individual pixels 111 may display desired colors so that a combination of the colors shown by the pixels 111 is shown as an image on the display panel 110.

The display panel 110 can provide a 2 Dimensional (2D) image through the plurality of pixels 111, and also can provide a 3 Dimensional (3D) image using a user's binocular disparity. In order to provide a 3D image, the display panel 110 may adopt one of a stereoscopic method and an autostereoscopic method.

The stereoscopic method requires a user to wear glasses, such as polarizing glasses and Liquid Crystal (LC) shutter glasses, for displaying 3D images. The stereoscopic method is widely applied in places, such as a theater, to display a 3D movie for a large number of viewers through a polarizing projector.

The autostereoscopic method provides 3D images through a lenticular lens, a parallax barrier, or a parallax illumination so that a user can view 3D images with his/her naked eyes. The autostereoscopic method is often applied to displays for games, home Televisions (TVs), displays for exhibition, etc. for an individual or a few viewers.

Hereinafter, it is assumed that the display apparatus 100 uses the autostereoscopic method of using a parallax barrier to provide 3D images.

The diffusion plate 130 may be disposed between the display panel 110 and the backlight apparatus 300. The diffusion plate 130 may be a translucent panel to diffuse light emitted from the backlight apparatus 300 throughout the surface to raise color and brightness uniformities of the screen. That is, the diffusion plate 130 may enhance the brightness of light emitted from the backlight apparatus 300, and supply the light with the enhanced brightness to the display panel 110.

That is, the diffusion plate 130 may enhance light emitted from the LEDs of the backlight apparatus 300, and maintain brightness uniformity throughout the entire screen.

The optical sheet 140 may be disposed between the display panel 110 and the diffusion panel 130. The optical sheet 140 may enhance the optical properties of light exiting a light guide plate 320, and provide the light with the enhanced optical properties to the display panel 110.

The support member 150 may support the display panel 110, the diffusion plate 130, the optical sheet 140, and the light source 160, which are disposed between the bezel 171 and the cover 172.

Also, the support member 150 may maintain distances between the display panel 110 and the optical sheet 140, between the diffusion plate 130 and the optical sheet 140, and between the diffusion plate 130 and the backlight apparatus 300.

The chassis 160 is a panel to connect various components required for displaying images and outputting sound, and various kinds of Printed Circuit Boards (PCBs) and input/output units may be mounted on the chassis 160.

The chassis 160 may be made of a metal having an excellent heat-dissipating property and high strength.

On the chassis 160, a driving module for driving the display panel 110 and the backlight apparatus 300 may be mounted.

The housing 170 may include the bezel 171 and the cover 172 as described above.

The bezel 171 may fix the display panel 110 supported by the support member 150, and also may be removably coupled with the support member 150 or the cover 172.

The bezel 171 may be coupled with the cover 172 to form accommodation space therein, and the display panel 110, the backlight apparatus 300, the diffusion plate 130, the optical sheet 140, and the chassis 160 may be disposed in the accommodation space.

The backlight apparatus 300 includes a light source apparatus disposed along the lateral edge(s) of the display panel 110 to emit light around the lateral edge(s) of the display panel 110. According to an exemplary embodiment, the backlight apparatus 300 may be implemented as an edge type light source apparatus, and more specifically, the backlight apparatus 300 may include a first light source 310 to generate light, and a light guide plate 320 to change a path of light generated by the first light source 310 and to emit the light toward the display panel 110.

The first light source 310 may include a plurality of light modules 311 arranged along one lateral edge of the light guide plate 320. The light modules 311 may be, for example but not limited to, light emitting diodes (LEDs) that generate light with high efficiency and low power.

If each light module 311 is implemented as a single LED, the first light source 310 may combine different colors of light generated by the plurality of light modules 311 to provide white light to the light guide plate 320. For example, the first light source 310 may include light modules 311 implemented with red LEDs, light modules 311 implemented with green LEDs, and light modules 311 implemented with blue LEDs. Also, in an exemplary embodiment, the first light source 310 may include light modules 311 implemented with cyan LEDs, light modules 311 implemented with magenta LEDs, and light modules 311 implemented with yellow LEDs.

On the other hand, if each light module 311 is implemented with a plurality of LEDs generating different colors, the first light source 310 may provide white light to the light guide plate 320 through a combination of light generated by each light module 311. For example, the first light source 310 may include a plurality of light modules 311 each configured with a red LED, a green LED, and a blue LED, or each configured with a cyan LED, a magenta LED, and a yellow LED.

Hereinafter, it is assumed that each light module 311 includes a red LED, a green LED, and a blue LED.

If light generated by the first light source 310 is incident into the light guide plate 320, the light guide plate 320 may provide the incident light to the display panel 110. In an exemplary embodiment, the light guide plate 320 may be made of a polycarbonate (PC)-based material or a plastic material, such as a polymethylmethacrylate (PMMA) that is an acrylic transparent resin as one of permeable materials capable of transmitting light, and may be in a shape of a rectangular plate.

Referring to FIG. 3, the light guide plate 320 according to an exemplary embodiment may include a first surface 321 to which light generated by the first light source 310 is incident, a second surface 322 through which the incident light exits the light guide plate 320, and a third surface 323 that is opposite to the second surface 322 of the light guide plate 320.

Specifically, the third surface 323 may include one or more non-exit areas R to totally reflect incident light within the light guide plate 320, and one or more exit areas S to reflect incident light toward the second surface 322 such that light can exit the light guide plate 320. As shown in FIG. 3, the exit areas S and the non-exit areas R may be formed at regular intervals across the surface 323. As a result, light incident to the light guide plate 320 may be reflected and exit to the outside, only through the exit areas S.

In order to cause light to exit through the exit areas S, a plurality of exit patterns 324 may be formed on the exit areas S of the third surface 323 of the light guide plate 320. The plurality of exit patterns 324 may be implemented in various shapes as long as they can reflect light toward the light guide plate 320. For example, the plurality of exit patterns 324 may be trigonal-prism patterns, lenticular patterns, or round-prism patterns. Specifically, the plurality of exit patterns 324 may be formed with a plurality of gradients so that light can exit toward a plurality of viewpoints.

Referring to FIGS. 4A and 4B, light incident through the first surface 321 may be reflected by the exit patterns 324 formed on the exit areas S and then exit through the second surface 322. As a result, the light guide plate 320 may emit the light reflected from the exit patterns 324 toward a plurality of viewpoints. In FIGS. 4A and 4B, an example of reflected light exiting toward 6 different viewpoints is shown.

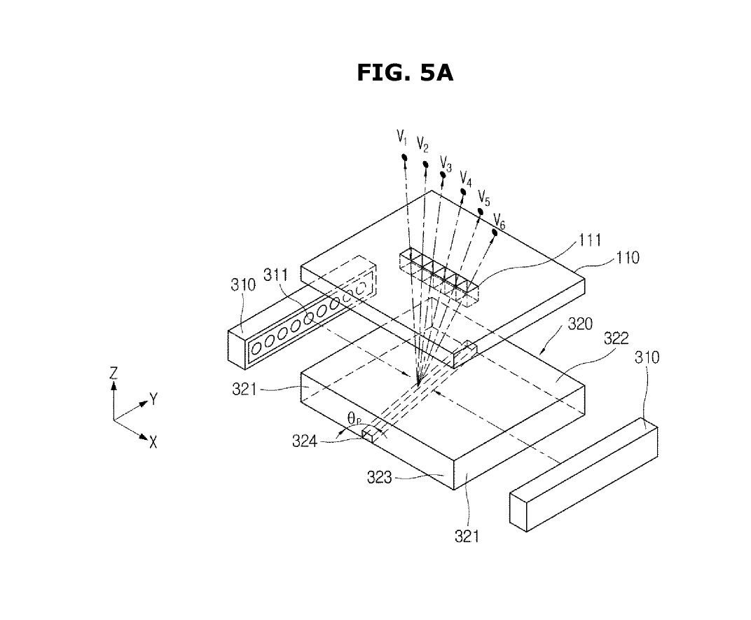

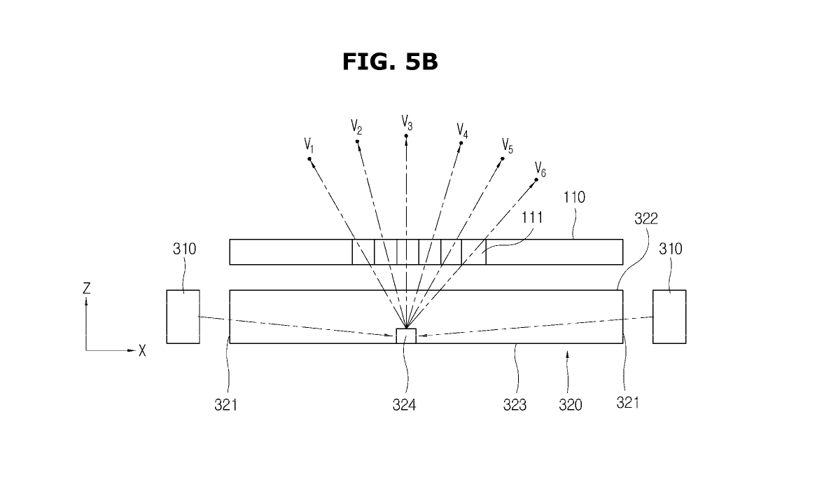

If a user's eyes are respectively located at different viewpoints of the plurality of viewpoints, binocular disparity may occur so that the user can recognize a 3D image. Hereinafter, a method for the display apparatus 100 to provide a 3D image will be described with reference to FIGS. 5A and 5B.

FIG. 5A is a perspective view for describing a 3D image providing method of the display apparatus 100 according to an exemplary embodiment, and FIG. 5B is a cross-sectional view for describing a 3D image providing method of the display apparatus 100 according to an exemplary embodiment. In FIGS. 5A and 5B, for convenience of description, only the display panel 110 and the backlight apparatus 300 are shown.

As shown in FIGS. 5A and 5B, the light modules 311 of the first light source 310 may generate light, and irradiate the light to the first surface 321 of the light guide plate 320. The light incident to the first surface 321 of the light guide plate 320 may be reflected by the exit patterns 324 formed in the exit areas S of the third surface 323. As described above with reference to FIGS. 4A and 4B, because the exit patterns 324 of the light guide plate 320 are formed with the plurality of gradients, the light reflected by the exit patterns 324 may exit toward a plurality of viewpoints corresponding to the plurality of gradients.

In FIGS. 5A and 5B, an example of light exiting the light guide plate 320 toward 6 viewpoints of V1 to V6 is shown. In this case, the light exited the light guide plate 320 toward the different viewpoints of V1 to V6 may pass through different pixels 111 of the display panel 110.

If a user's eyes are respectively located at different viewpoints among the viewpoints of V1 to V6, the user's eyes can recognize only pixels 111 through which light is transmitted toward the corresponding viewpoints. As a result, binocular disparity may occur so that the user can feel a three dimensional effect from an image displayed on the display panel 110.

When the display apparatus 100 provides a user with 3D images according to the above-described method, the display apparatus 100 may provide a 3D image of a lower resolution than that of a 2D image. More specifically, the display apparatus 100 may provide a 3D image of a resolution resulting from dividing the resolution of a 2D image by the number of viewpoints. The display apparatus 100 shown in FIGS. 5A and 5B can provide a 3D image of a resolution that is ⅙ of the resolution of a 2D image.

For this reason, the display apparatus 100 needs to display 3D images of a higher resolution.

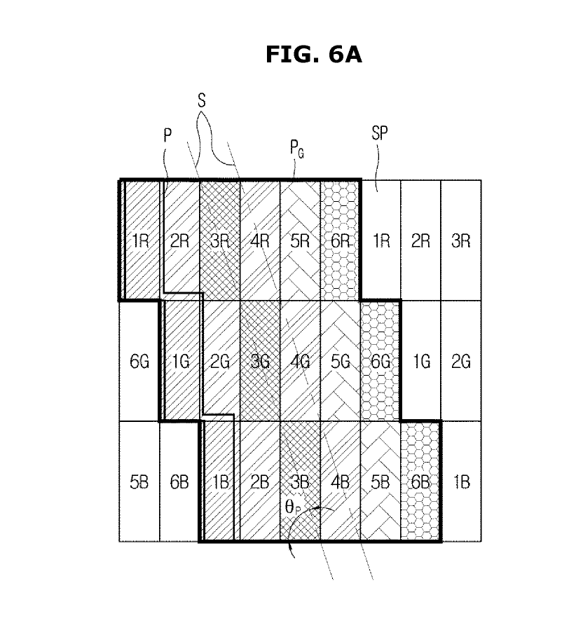

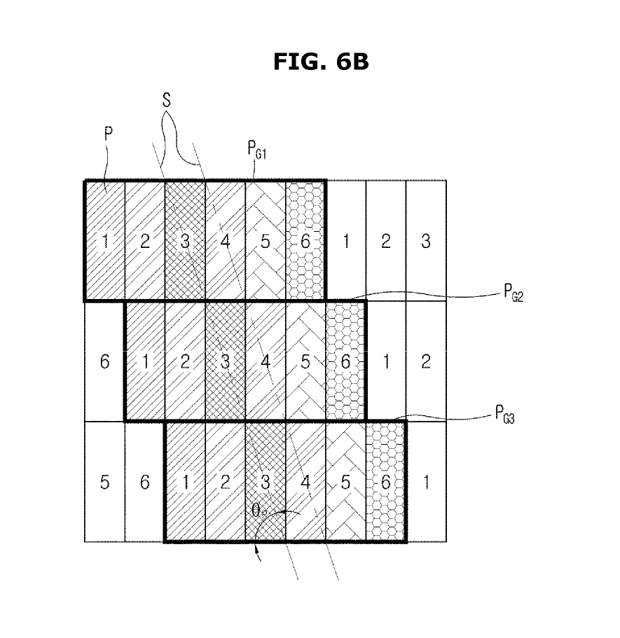

Hereinafter, a method of displaying 3D images of a high resolution will be described with reference to FIGS. 6A, 6B, 7, and 8, below.

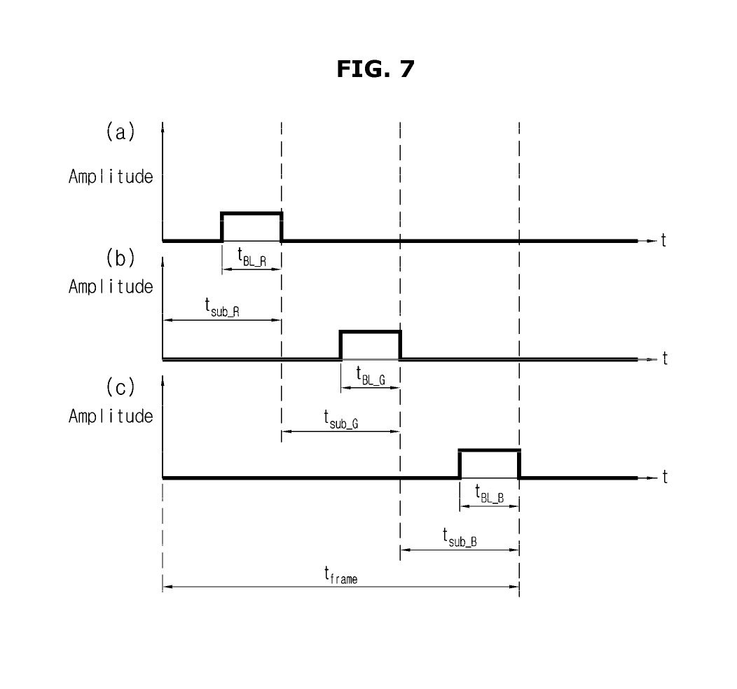

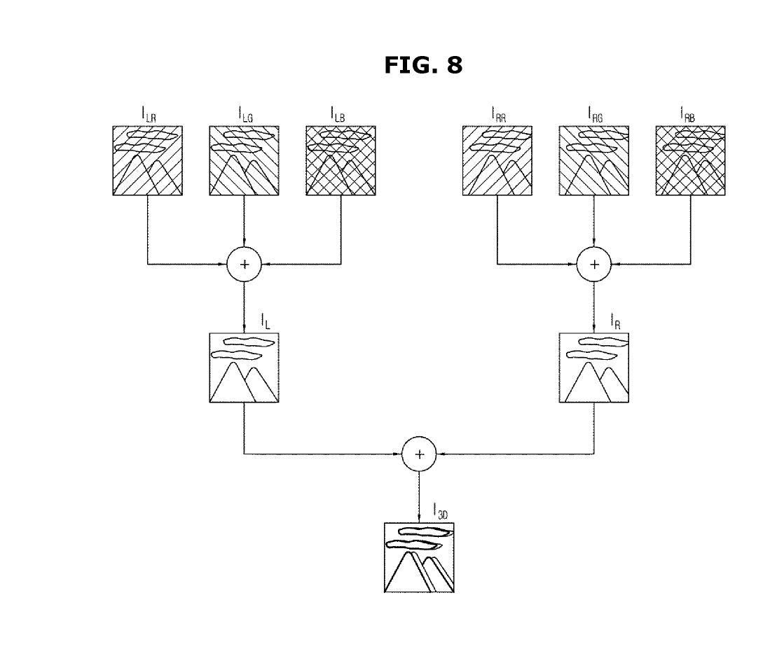

FIGS. 6A and 6B are views for describing a space division driving method and a time division driving method, FIG. 7 is a view for describing operation of the first light source 310 according to an exemplary embodiment, and FIG. 8 is a view for describing an image displayed on the display apparatus 100 according to an exemplary embodiment and an image recognized by a user.

FIG. 6A is a view for describing the space division driving method. The display panel 110 shown in FIG. 6A may be configured with an arrangement of a plurality of pixels P each configured with a plurality of sub pixels SP that respectively display different colors. Hereinafter, for convenience of description, a group of adjacent pixels P that are recognized at different viewpoints is referred to as a pixel group P_{G}. In FIG. 6A, a number written in each sub pixel SP represents a viewpoint at which the corresponding sub pixel SP is recognized, and a letter written in each sub pixel SP represents a color which the corresponding sub pixel SP shows.

In the space division driving method, a color filter is installed between the light guide plate 320 and the display panel 110. More specifically, if the first light source 310 generates white light, the light guide plate 320 may emit the white light to the display panel 110. At this time, the color filter may filter light of predetermined colors from the white light, and then provide the light of the predetermined colors to the display panel 110. For example, the color filter may filter red light, green light, and blue light from the white light, and then provide the red light, the green light, and the blue light respectively to different sub pixels SP constructing a pixel P.

A pixel P includes a sub pixel SP through which the red light is transmitted, a sub pixel SP through which the green light is transmitted, and a sub pixel SP through which the blue light is transmitted. A color that is represented by the pixel P may be decided by a combination of light transmitted through the plurality of sub pixels SP constructing the corresponding pixel P. Accordingly, the user can view a 2D image of a resolution corresponding to ⅓ of the number of the sub pixels SP included in the display panel 110.

A 3D image having 6 viewpoints as shown in FIGS. 5A and 5B has a resolution corresponding to ⅙ of that of a 2D image so that a user can view the 3D image of the resolution corresponding to 1/18 of the number of the sub pixels SP of the display panel 110. In the example of FIG. 6A, each of a user's eyes may recognize one color through the pixel group P_{G} configured with the pixels P for the 6 viewpoints.

Accordingly, when the space division driving method is used, the display apparatus 100 may provide 3D images having a very low resolution.

In order to overcome the problem, the backlight apparatus 300 and the display apparatus 100 may adopt the time division driving method, more specifically, a Field Sequential Color (FSC) method. The FSC method is to sequentially provide light of different colors to the display panel 110 to enable a user to recognize a combination of the sequentially provided light as one color.

FIG. 6B is a view for describing the FSC method. The display panel 110 of FIG. 6B may be configured with an arrangement of a plurality of pixels P that sequentially display different colors. Hereinafter, for convenience of description, groups of adjacent pixels that are recognized at different viewpoints are referred to as pixel groups P_{G1}, P_{G2}, and P_{G3}. In FIG. 6B, a number written in each pixel P represents a viewpoint at which the corresponding pixel P is recognized. Referring to FIG. 6B, red light may be first provided to a pixel P, green light may be successively provided to the pixel P, and then blue light may be provided to the pixel P. Due to afterimage effect, a user can recognize a combination of red, green, and blue transmitted through the pixel P as a color of the corresponding pixel P.

As a result, the FSC method, unlike the space division driving method, allows a user to directly recognize a color of each pixel P through the afterimage effect. Accordingly, the user can view 2D images having a resolution that is 3 times higher than in the space division driving method.

A 3D image having 6 viewpoints as shown in FIGS. 5A and 5B has a resolution corresponding to ⅙ of that of a 2D image so that a user can view the 3D image of the resolution corresponding to ⅙ of the number of the pixels P of the display panel 110. In the example of FIG. 6B, a user's eyes may each recognize one color through the pixel group P_{G1}, P_{G2}, or P_{G3} configured with the pixels P for the 6 viewpoints.

As such, in the space division driving method, a pixel group P_{G} that is recognized as one color in a 3D image may be configured with 18 sub pixels SP. In contrast, in the FSC method, a pixel group P_{G1}, P_{G2}, or P_{G3} may be configured with 6 pixels P.

Accordingly, the FSC method can provide 3D images of higher resolutions than the space division driving method.

When the FSC method is adopted, operation of the first light source 310 will be described with reference to FIG. 7, below. In FIG. 7, (a) is a signal diagram showing a driving signal for red LEDs, (b) is a signal diagram showing a driving signal for green LEDs, and (c) is a signal diagram showing a driving signal for blue LEDs.

The FSC method may divide a frame of a 3D image into 3 sub frames. In the sub frames, a red image, a green image, and a blue image among a plurality of sub frame images constructing a frame image of the 3D image may be respectively and sequentially provided. Because a user's eyes cannot recognize image discontinuation at a frame rate of 45 Hz or more, a frame rate for the sub frame images may be set to 45 Hz or more.

Referring to FIG. 7, a frame time period t_{frame} of the 3D image may be divided into three sub frame periods t_{sub}_{_}_{R}, t_{sub}_{_}_{G}, and t_{sub}_{_}_{B}. Each sub frame period may include an addressing section in which data is applied to the data lines of the display panel 110, a waiting section that is taken for liquid crystals to react by an electric field formed according to the applied data, and a flashing section in which the first light source 310 generates light.

In FIG. 7, a flashing section t_{BL-R} in which red light is generated to display a red sub frame image, a flashing section t_{BL-G} in which green light is generated to display a green sub frame image, and a flashing section t_{BL-B} in which blue light is generated to display a blue sub frame image are shown.

The display apparatus 100 may transmit red light generated during the flashing section t_{BL-R} through the display panel 110 to provide a plurality of different red viewpoint images for a plurality of viewpoints, and may transmit green light generated during the flashing section t_{BL-G} through the display panel 110 to provide a plurality of different green viewpoint images for the plurality of viewpoints. In the same way, the display apparatus 100 may transmit blue light generated during the flashing section t_{BL-B} through the display panel 110 to provide a plurality of different blue viewpoint images for the plurality of viewpoints.

Referring to FIG. 8, a user may receive a red image I_{LR}, a green image I_{LG}, and a blue image I_{LB} through his/her left eye located at a specific viewpoint. As a result, the user can recognize a viewpoint image I_{L}, which is a combination of the red image I_{LR}, the green image I_{LG}, and the blue image I_{LB}.

Also, the user may receive a red image I_{RR}, a green image I_{RG}, and a blue image I_{RB} through his/her right eye located at another viewpoint that is different from the specific viewpoint. As a result, the user can recognize a viewpoint image I_{R}, which is a combination of the red image I_{RR}, the green image I_{RG}, and the blue image I_{RB}.

Finally, due to binocular disparity, the user can recognize a 3D image I_{3D} through the viewpoint images I_{L} and I_{R}.

The embodiments shown in FIGS. 4A and 4B to 6A and 6B have been described in a case that the exit patterns 324 of the light guide plate 320 are formed in a predetermined direction on the third surface 323. That is, the embodiments shown in FIGS. 4A and 4B to 6A and 6B have been described in a case that the exit patterns 324 of the light guide plate 320 are formed in a predetermined direction having a an acute angle θ_{P} between the predetermined direction and the x axis (the incidence direction of the light generated by the first light source). Or, the exit patterns 324 may extend perpendicularly on the third surface 323 of the light guide plate 320.

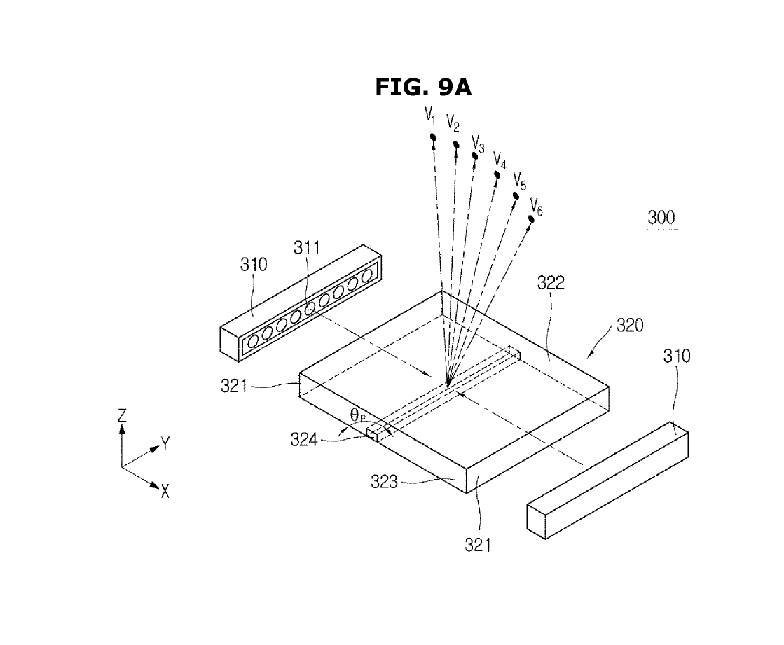

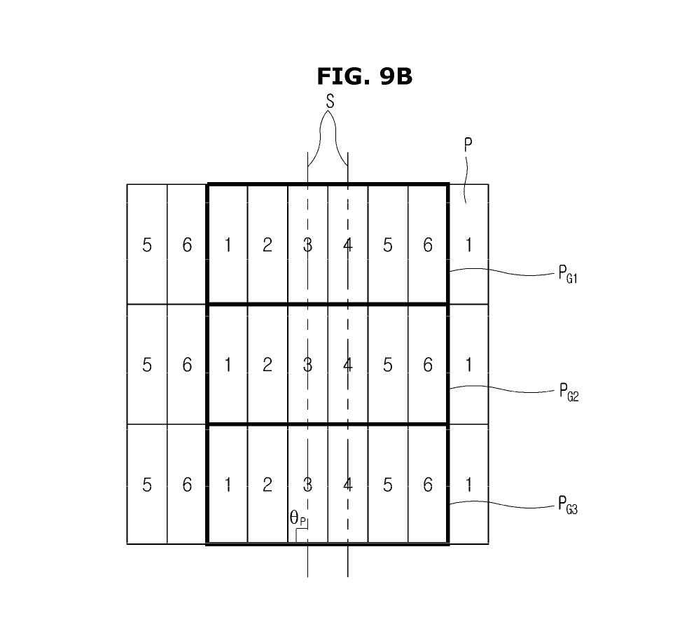

FIGS. 9A and 9B are views for describing operation of the backlight apparatus 300 according to an exemplary embodiment. In the backlight apparatus 300 of FIGS. 9A and 9B, only one exit pattern 324 is shown for simplicity.

As shown in FIG. 9A, because the exit pattern 324 is formed in a direction of 90 degrees, the pixel group P_{G} of the display panel 110 may need to be arranged in correspondence to the exit pattern 324.

Referring to FIG. 6B, the exit area S in which the exit pattern 324 is formed may be formed with an acute angle θ_{P}. In this case, the pixel group P_{G} may be formed in a direction in which the exit pattern 324 extends. As a result, the pixel group P_{G} of FIG. 6B may also be set to have the same angle θ_{P}.

Also, if the exit area S is formed with an angle θ_{P} of 90 degrees, the pixel group P_{G} of the display panel 110 may also be arranged in the direction in which the exit pattern 324 extends, as shown in FIG. 9B.

Meanwhile, the display apparatus 100 may selectively provide 2D images and 3D images. In order to selectively provide 2D images and 3D images, the display apparatus 100 may further include a second light source 330 to sequentially generate light of different colors so that light can exit through the second surface 322 of the light guide plate 320.

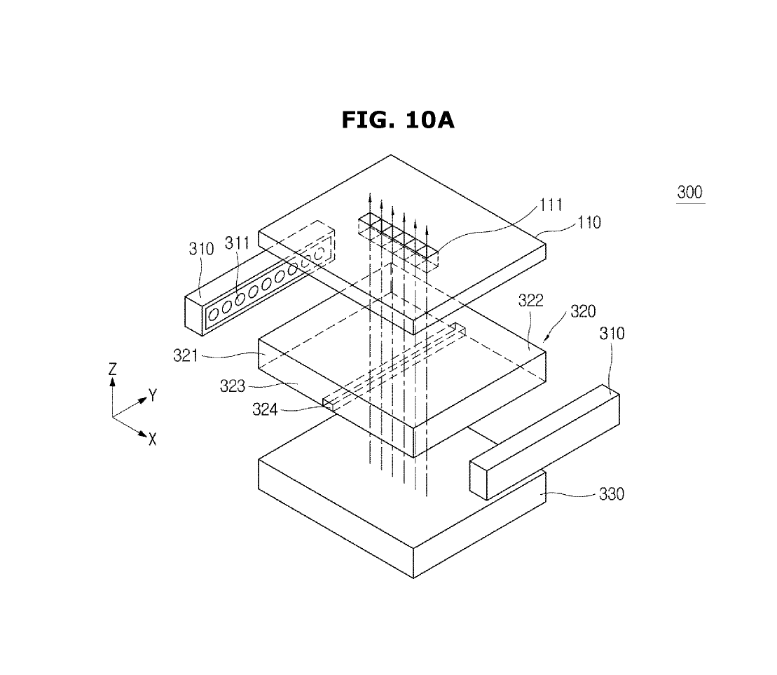

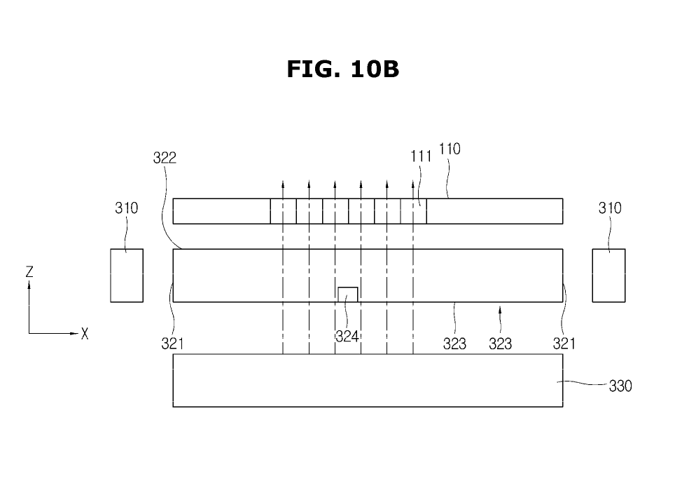

FIG. 10A is a perspective view for describing a 2D image providing method of the display apparatus 300 according to an exemplary embodiment, and FIG. 10B is a cross-sectional view for describing a 2D image providing method of the display apparatus 300 according to an exemplary embodiment. In FIGS. 10A and 10B, for convenience of description, only the display panel 110 and the backlight apparatus 300 are shown.

In the case of providing 2D images, unlike the case of providing 3D images, light needs to exit uniformly through the second surface 322 of the light guide plate 320. In order for the light to exit uniformly, the second light source 330 may be positioned behind the third surface 323 of the light guide plate 320, as shown in FIGS. 10A and 10B.

As shown in FIG. 10B, light generated by the second light source 330 may be transmitted through the third surface 323 of the light guide plate 320, and then exit the light guide plate 320 to the display panel 110 through the second surface 322. As a result, a user's eyes can recognize all the pixels 111 of the display panel 110.

Also, like the first light source 310, the second light source 330 may sequentially generate light of different colors according to the FSC method. That is, the second light source 330 may operate according to the driving signals shown in FIG. 7.

As a result, the display apparatus 100 can provide 2D images of a resolution corresponding to the number of the pixels 111 of the display panel 110.

According to an aspect of the backlight apparatus and the display apparatus as described above, by transmitting light of different colors through each pixel, compared to the method of transmitting light of different colors through a plurality of pixels using a color filter, it is possible to provide 3D images of a high resolution.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A backlight apparatus comprising:
a light source configured to sequentially generate first light of a first color and second light of a second color; and
a light guide plate configured to receive the first light and the second light, the light guide plate comprising a plurality of exit areas configured to emit the first light and the second light toward a plurality of viewpoints.

2. The backlight apparatus according to claim 1, wherein the light guide plate further comprises:
a first surface onto which the first light and the second light generated by the light source are incident;
a second surface through which the first light and the second light exits; and
a third surface, opposite the second surface,
wherein the plurality of exit patterns are arranged at regular intervals on the third surface and the plurality of exit patterns reflect light incident through the first surface toward the plurality of viewpoints through the second surface.

3. The backlight apparatus according to claim 1, wherein the first light and the second light display a plurality of sub viewpoint images constructing a plurality of different viewpoint images at the plurality of viewpoints.

4. The backlight apparatus according to claim 3, wherein the light source sequentially generates the first light and the second light for each frame period of the plurality of different viewpoint images.

5. The backlight apparatus according to claim 1, wherein the light source sequentially generates red light, green light, and blue light in a predetermined order.

6. The backlight apparatus according to claim 1, wherein the light source sequentially generates cyan light, magenta light, and yellow light in a predetermined order.

7. The backlight apparatus according to claim 2, further comprising a second light source configured to sequentially generate second light of the first color and first light of the second color toward the second surface.

8. The backlight apparatus according to claim 7, wherein the second light source is positioned behind the third surface, and the second light of the first color and the first light of the second color generated by the second light source are incident to the light guard plate through the third surface and then exits through the second surface.

9. The backlight apparatus according to claim 1, wherein the plurality of exit areas extend perpendicularly to an incidence direction of the light generated by the light source on a surface of the light guide plate.

10. The backlight apparatus according to claim 1, wherein the plurality of exit areas extend in a predetermined direction on a surface of the light guide plate.

11. A display apparatus comprising:
a backlight apparatus configured to sequentially emit first light of a first color and second light of a second color toward a plurality of viewpoints from a plurality of predetermined areas arranged at regular intervals; and
a display panel configured to transmit the first light and the second light to provide a plurality of different sub viewpoint images at the plurality of viewpoints.

12. The display apparatus according to claim 11, wherein the backlight apparatus comprises:
a light source configured to sequentially generate the first light and the second light; and
a light guide plate configured to receive the first light and the second light, the light guide plate comprising a plurality of exit areas configured to emit the first light and the second light toward a plurality of viewpoints.

13. The display apparatus according to claim 12, wherein the light guide plate further comprises:
a first surface onto which the first light and the second light generated by the light source are incident;
a second surface through which the first light and the second light exits; and
a third surface opposite to the second surface,
wherein the plurality of exit patterns are arranged at regular intervals on the third surface and the plurality of exit patterns reflect light incident through the first surface toward the plurality of viewpoints through the second surface.

14. The display apparatus according to claim 12, wherein the first light and the second light sequentially display the plurality of sub viewpoint images constructing the plurality of different viewpoint images at the plurality of viewpoints.

15. The display apparatus according to claim 14, wherein the first light source sequentially generates the first light and the second light for each frame period of the plurality of different viewpoint images.

16. The display apparatus according to claim 12, wherein the light source sequentially generates red light, green light, and blue light in a predetermined order.

17. The display apparatus according to claim 12, wherein the light source sequentially generates cyan light, magenta light, and yellow light in a predetermined order.

18. The display apparatus according to claim 13, further comprising a second light source configured to sequentially generate second light of the first color and first light of the second color toward the second surface of the light guide plate,
wherein the second light source is positioned behind the third surface, and the second light of the first color and the first light of the second color generated by the second light source are incident to the light guard plate through the third surface and then exits through the second surface.

19. The display apparatus according to claim 12, wherein the plurality of exit areas extend perpendicularly to an incidence direction of the light generated by the first light source on a surface of the light guide plate.

20. The display apparatus according to claim 12, wherein the plurality of exit areas extend in a predetermined direction on a surface of the light guide plate.
